(19) United States
(12) Patent Application Publication
(10) Pub. No.: US 2014/0118819 A1
(43) Pub. Date: May 1, 2014

(54) OPTICAL DEVICE, IMAGING SYSTEM WHICH INCORPORATES THE OPTICAL DEVICE AND METHOD IMPLEMENTED BY THE IMAGING SYSTEM FOR IMAGING A SPECIMEN

(71) Applicant: CORNING INCORPORATED, Corning, NY (US)

(72) Inventor: MARK C. SANSON, Macedon, NY (US)

(73) Assignee: CORNING INCORPORATED, Corning, NY (US)

(21) Appl. No.: 14/054,120

(22) Filed: Oct. 15, 2013

Related U.S. Application Data
(60) Provisional application No. 61/720,653, filed on Oct. 31, 2012.

(51) Int. Cl. G02B 17/06

(52) U.S. Cl. CPC G02B 17/0652
USPC 359/366; 359/859

(57) ABSTRACT

An optical device is described herein which is a four mirror objective with a large numerical aperture and a small central obscuration. The four mirror objective places two Schwarzschild-like objectives in series with respect to one another. This allows a large numerical aperture, a long working distance, and small central obscuration. Each objective has a primary and secondary mirror. An imaging device and method for imaging a specimen are also described herein.

This application claims the benefit of priority under 35 U.S.C. §119 of U.S. Provisional Application Ser. No. 61/720,653 filed on Oct. 31, 2012 the content of which is relied upon and incorporated herein by reference in its entirety.

### TECHNICAL FIELD

The present invention relates to an optical device, an imaging system which incorporates the optical device, and a method implemented by the imaging system for imaging a specimen.

### BACKGROUND

Referring to FIGS. 1A-1B (PRIOR ART), there are two diagrams which are used to help explain the well known Schwarzschild objective 100 and a problem associated with the Schwarzschild objective 100. As shown in FIG. 1A (PRIOR ART), the Schwarzschild objective 100 has one finite conjugate 101 and an on-axis configuration 103 that includes a primary concave mirror 102 with an aperture 104 located in a center thereof, and a secondary convex mirror 106. The Schwarzschild objective 100 is configured such that a source light 108 passes through the aperture 104 in the primary concave mirror 102 and due to the on-axis configuration 101 a portion 110 of the source light 108 which hits a central portion 112 of the secondary convex mirror 106 is reflected back through the aperture 104 in the primary concave mirror 102 and is lost. The loss of the portion 110 of the source light 108 causes a reduction of image contrast (transmission efficiency). This undesirable effect is known as central obscuration 110′.

As shown in FIG. 1B (PRIOR ART), there is a graph 114 illustrating different modulation transfer function curves 116a (unobstructed), 116b (25% obstruction), and 116c (50% obstruction) of the Schwarzschild objective 100 (note: the x-axis represents spatial frequency and the y-axis represents modulation). The modulation transfer function is a measure of optical transmission efficiency as a function of spatial frequency (assuming the secondary convex mirror 106 is uniformly illuminated). The lower spatial frequencies correspond to larger feature sizes. For instance, the modulation transfer function curve 116c has a shape which indicates that there is a lower image contrast at larger feature sizes when there is an increase in a numerical aperture (NA) 118 of the Schwarzschild objective 100 (note: NA is a dimensionless number which characterizes the range of angles over which the Schwarzschild objective 100 can accept or emit light 108—NA=n sin θ where n is the index of refraction of the medium in which the objective 100 is working and θ is the half-angle of the maximum cone of the light that can enter or exit the objective 100 with respect to an image point P). Therefore, the larger the numerical aperture (NA) 118 in the Schwarzschild objective 100 then the greater the loss in the image contrast through the central obscuration 110′. The typical Schwarzschild objective 100 has a numerical aperture (NA) 118 of approximately 0.3 (with a 30% central obscuration 110′) but can go upto to about 0.65 (with a 50% central obscuration 110′). Hence, there is a need for an optical device which has reflective components but is configured to have a large numerical aperture (NA) while at the same time have a small central obscuration.

### SUMMARY

An optical device, an imaging system which incorporates the optical device, and a method implemented by the imaging system for imaging a specimen which address the aforementioned need have been described in the independent claims of the present application. Advantageous embodiments of the optical device, the imaging system which incorporates the optical device, and the method implemented by the imaging system for imaging a specimen have been described in the dependent claims.

In one aspect, the present invention provides an optical device which comprises a first objective and a second objective. The first objective has a first primary concave mirror with an aperture located in a center thereof, and a first secondary convex mirror. The second objective has a second primary concave mirror with an aperture located in a center thereof, and a second secondary convex mirror. The first objective and the second objective are placed in series on an axis with respect to one another. The second objective has a relatively large numerical aperture and the first objective has a relatively small numerical aperture.

In another aspect, the present invention provides an imaging system for imaging a specimen. The imaging system comprises a viewing-detection system and an optical device. The optical device comprises a first objective and a second objective. The first objective has a first primary concave mirror with an aperture located in a center thereof, and a first secondary convex mirror. The second objective has a second primary concave mirror with an aperture located in a center thereof, and a second secondary convex mirror. The viewing-detection system is positioned a predetermined distance from the first objective. The specimen is positioned a predetermined distance from the second objective. The first objective and the second objective are placed in series on an axis with respect to one another such that light from the specimen passes through the second objective which has a relatively large numerical aperture and then the light passes through the first objective which has a relatively small numerical aperture before being received by the viewing-detection system.

In another aspect, the present invention provides a method for imaging a specimen. The method comprising the steps of: (a) providing a viewing-detection system; (b) providing an optical device which comprises a first objective and a second objective which are placed in series on an axis with respect to one another, wherein the first objective has a first primary concave mirror with an aperture located in a center thereof, and a first secondary convex mirror, and wherein the second objective has a second primary concave mirror with an aperture located in a center thereof, and a second secondary convex mirror; (c) positioning the viewing-detection system at a predetermined distance from the first objective; (d) positioning the specimen at a predetermined distance from of the second objective; and (e) receiving, at the viewing-detection system, light from the specimen which had first passed through the second objective which has a relatively large numerical aperture and then the light had passed through the first objective which has a relatively small numerical aperture.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be had by reference to the following detailed description when taken in conjunction with the accompanying drawings wherein:

FIGS. 1A-1B (PRIOR ART) are two diagrams which are used to help explain the well known Schwarzschild objective and a problem associated with the Schwarzschild objective;

FIG. 2 is a block diagram of an optical device which is configured in accordance with an embodiment of the present invention;

FIGS. 3A-3D are diagrams associated with an exemplary optical device which is configured to have a magnification of 36× while achieving an acceptable 0.7 NA, 25 mm working distance, a 2.7 mm diameter object field, and 20% central obscuration in accordance with an embodiment of the present invention;

FIGS. 4A-4B are diagrams associated with another exemplary optical device which is configured to have a magnification of 20× while achieving an acceptable 0.6 NA, 25 mm working distance, a 2.7 mm diameter object field, and 20% central obscuration in accordance with an embodiment of the present invention;

FIG. 5 is a diagram of an imaging system which incorporates the optical device shown in FIG. 2 and is configured to image a specimen in accordance with an embodiment of the present invention;

FIG. 6 is a block diagram of another optical device which is configured in accordance with another embodiment of the present invention;

FIG. 7 is a diagram of an imaging system which incorporates the optical device shown in FIG. 6 and is configured to image a specimen in accordance with another embodiment of the present invention; and

FIG. 8 is a flowchart illustrating the steps of a method for imaging a specimen using the optical device shown in FIG. 2 or 6 in accordance with an embodiment of the present invention.

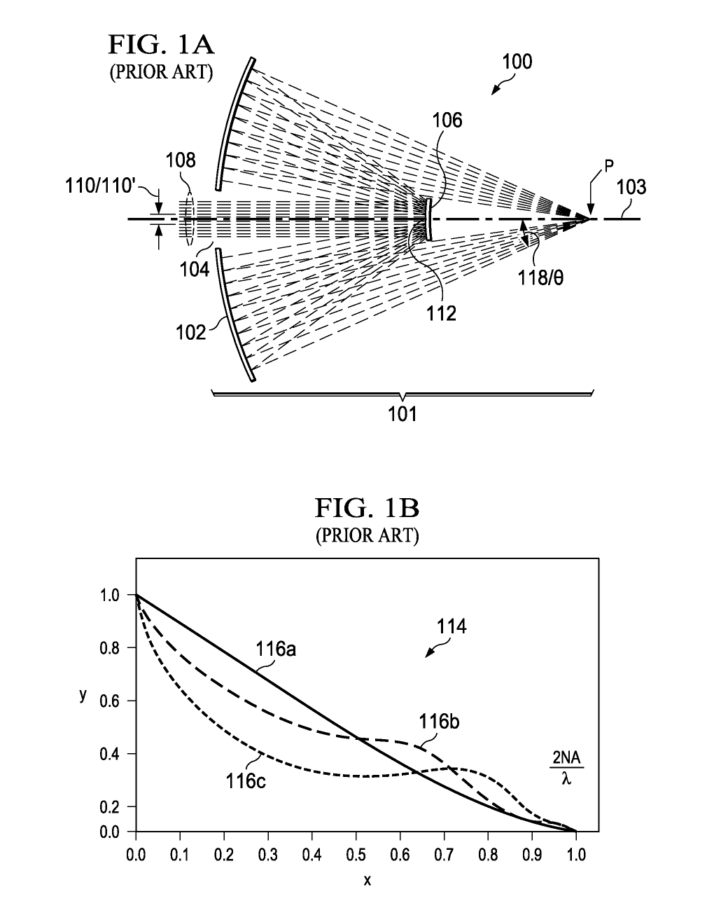

### DETAILED DESCRIPTION

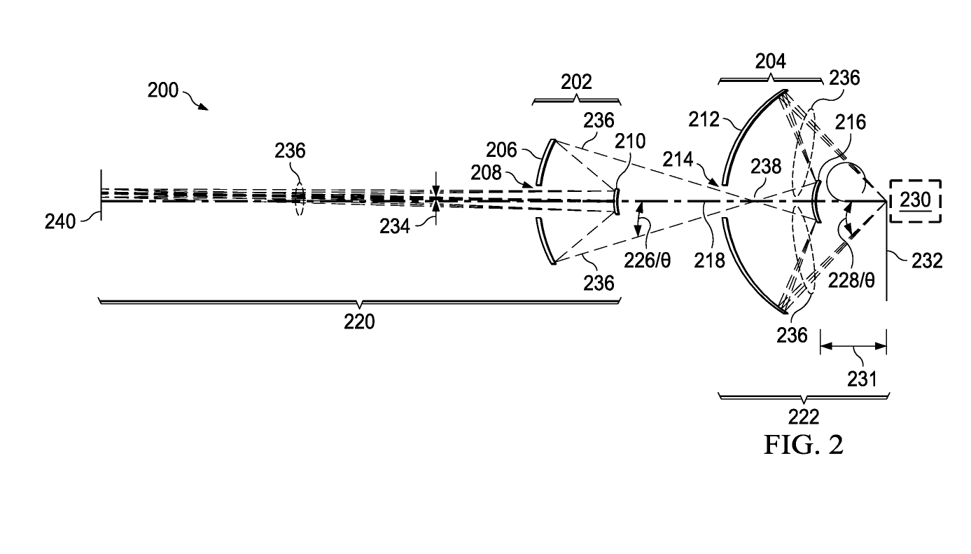

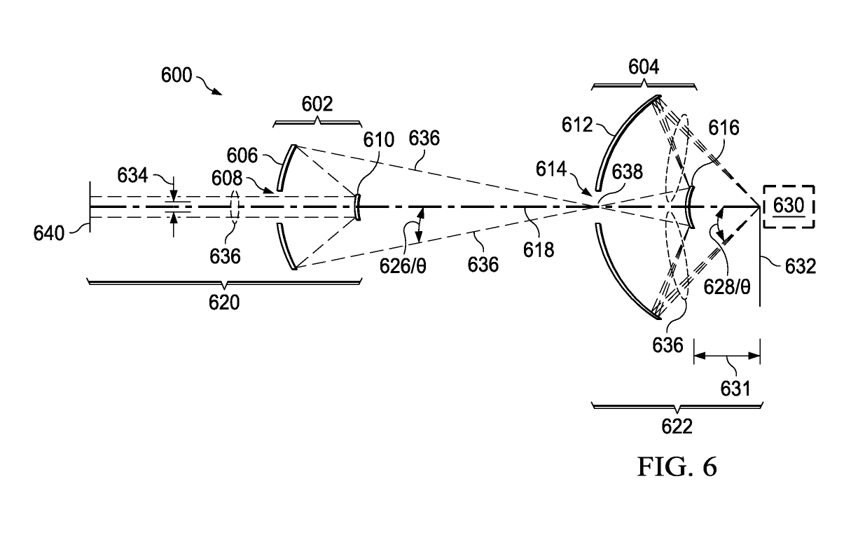

Referring to FIG. 2, there is a block diagram of an optical device 200 which is configured in accordance with an embodiment of the present invention. The optical device 200 includes a first objective 202 and a second objective 204. The first objective 202 has a first primary concave mirror 206 with an aperture 208 located in the center thereof, and a first secondary convex mirror 210. The second objective 204 has a second primary concave mirror 212 with an aperture 214 located in a center thereof, and a second secondary convex mirror 216. As shown, the first objective 202 and the second objective 204 are placed in series on an axis 218 with respect to one another in a manner such that the first objective 202 has a relatively long conjugate 220 and the second objective 204 has a relatively short conjugate 222. In particular, the first objective 202 is used in a finite-finite conjugate form and the second objective 204 is used a finite-finite conjugate form which are associated with a microscopy setup (compare to FIG. 6). In this microscopy setup, the first objective 202 has a relatively small numerical aperture 226, and the second objective 204 has a relatively large numerical aperture 228 (note: NA 226 and 228 is a dimensionless number which characterizes the range of angles over which the corresponding objective 202 and 204 can accept or emit light 236—NA=n sin θ where n is the index of refraction of the medium in which the corresponding objective 202 and 204 is working and θ is the half-angle of the maximum cone of the light 236 that can enter or exit the corresponding objective 202 and 204 with respect to an image point P). In particular, the optical device 200 has reflective components 206, 210, 212 and 216 that are configured to have the large NA 228 with respect to a specimen 230 (e.g., sample 230, wafer 230) while at the same time have a small central obscuration 234. The specimen 230 which is to be imaged is placed at the short conjugate's focus plane 232. The following is a detailed discussion about how light 236 from the specimen 230 is collected by the optical device 200 and then emitted from the optical device 200.

The optical device 200 is configured such that the second primary concave mirror 212 receives the light 236 from the specimen 230 which is located a predetermined distance 231 (e.g., working distance 231) from the second objective 204. The second primary concave mirror 212 focuses the light 236 toward the second secondary convex mirror 216. The second secondary convex mirror 216 reflects the light 236 to produce an intermediate image 238 prior to the aperture 214 in the second primary concave mirror 212 so that the light 236 can pass through the aperture 214 located in the second primary concave mirror 212. Then, the first primary concave mirror 206 collects the light 236 which passed through the aperture 214 in the second primary concave mirror 212 and focuses the light 236 toward the first secondary convex mirror 210. The first secondary convex mirror 210 reflects the light 236 through the aperture 208 in the first primary concave mirror 206 such the light 236 is focused on the long conjugate plane 240.

As shown, the light 236 from the second objective 204 enters the first objective 202 which has the smaller NA 226 than the NA 228 of the second objective 204 which collected the light 236 from the specimen 230. This particular setup of the optical device 200 effectively minimizes the central obscuration 234. In one example, the optical device 200 can be configured to have a magnification in a range of about 10× to 20× while the first objective 202 has a relatively small numerical aperture 226 in the range of about 0.2, and the second objective 204 has a relatively large numerical aperture 228 in the range of about 0.6-0.7, and the central obscuration 234 is less than 35%. The exemplary optical device 200 also has a working distance 231 of about 20 mm which is the distance from the second objective 204 to the specimen 230. In addition, this particular setup of the optical device 200 allows aberrations in the first and second objectives 202 and 204 to be corrected at different locations. More specifically, since the optical system 200 utilizes all reflective surfaces in the first and second objectives 202 and 204 this enables both spherical surfaces as well as aspherical surfaces to be used therein as desired to correct aberrations and improve the wavefront performance of the objectives 202 and 204. Referring again to the exemplary optical device 200 which has a 10× to 20× magnification it has been determined that the first primary concave mirror 206 and the second primary concave mirror 212 can have ashperic surfaces while the first secondary convex mirror 210 and the second secondary convex mirror 216 have spherical surfaces. In fact, this exemplary optical system 200 can have first and second objectives 202 and 204 that are dimensioned per TABLES #1-3:

TABLE # 1

| | | | Semi- |
|---|---|---|---|
| Radius | Thickness | Glass | Diameter |
| Infinity | 136.7053 | | 1.3500 |
| Infinity | 41.8846 | | 5.4391 |
| 25.8616 | 0.0000 | Mirror | 6.7185 |
| | | (first secondary convex mirror 210) | |
| Infinity | −41.8846 | | 7.2882 |
| 78.8675 | 0.0000 | Mirror | 30.3065 |
| | | (first primary concave mirror 206*) | |
| Infinity | 41.8846 | | 31.5778 |
| 25.8616 | 101.1605 | | 6.7185 |
| Infinity | 28.4460 | | 1.3414 |
| 13.0236 | 0.0000 | Mirror | 5.3652 |
| | | (second secondary convex mirror 216) | |
| Infinity | −28.4460 | | 7.4108 |
| 42.2710 | 0.0000 | Mirror | 31.9790 |
| | | (second primary concave mirror 212*) | |
| Infinity | 28.4460 | | 42.9885 |
| 13.0236 | 28.5082 | | 5.3652 |

* The first and second primary concave mirrors 206 and 212 can be even aspheres per TABLES #2 and 3:

TABLE #2
(First primary concave mirror 206)

| | Par 0 | 2nd Order | 4th Order | 6th Order | 8th Order |
|---|---|---|---|---|---|
| Conic | (unused) | T . . . | T . . . | T . . . | T . . . |
| 0.0000 | | 0.0000 | −4.1E−008 | −6.7E−12 | −1.1E−15 |

TABLE #3
(Second primary concave mirror 212)

| | Par 0 | 2nd Order | 4th Order | 6th Order | 8th Order |
|---|---|---|---|---|---|
| Conic | (unused) | T . . . | T . . . | T . . . | T . . . |
| −0.0188 | | 0.0000 | 1.28E−009 | 3.94E−013 | −2.6E−16 |

Where the even ashperic equation is as follows:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

Where c is the curvature (1/radius), z is the sag of the surface, r is the radial height, k is the conic constant, and the α are the coefficients.

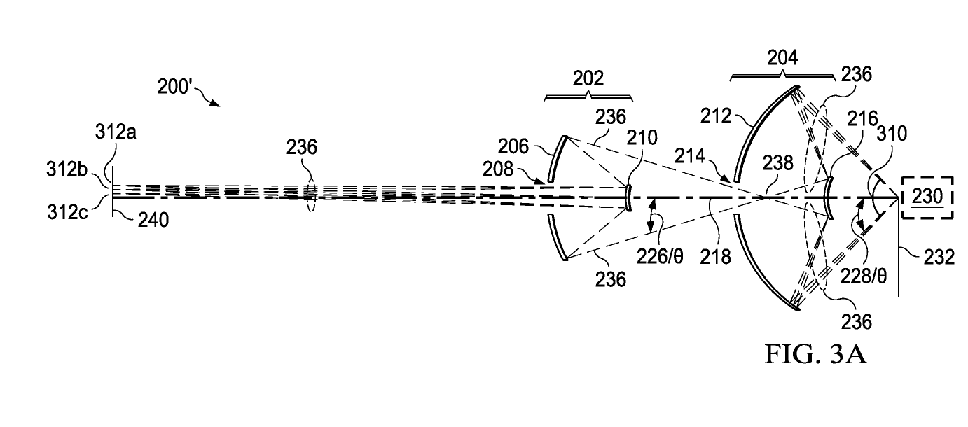

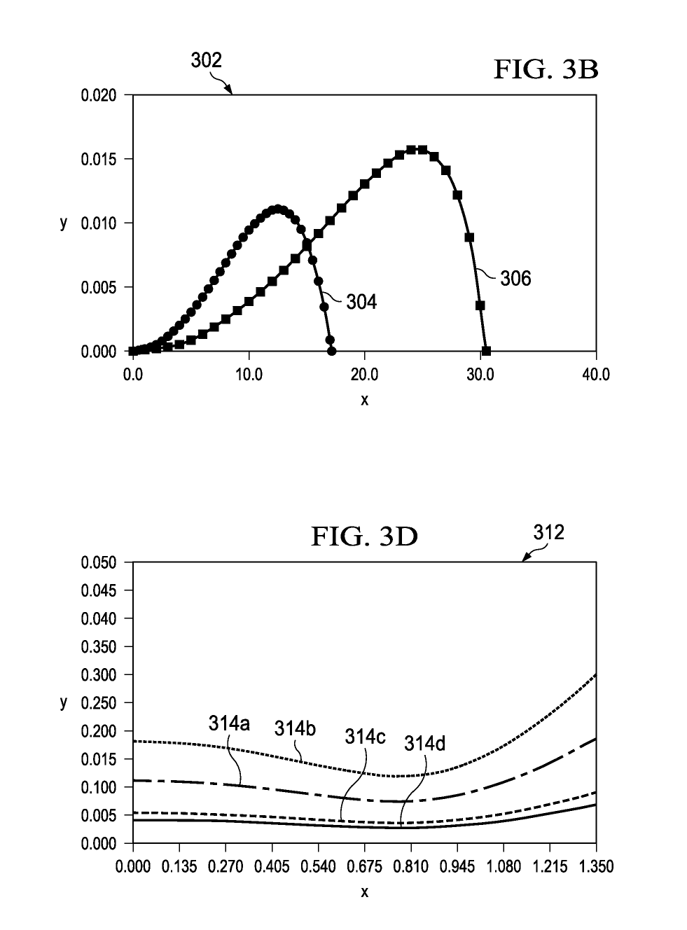

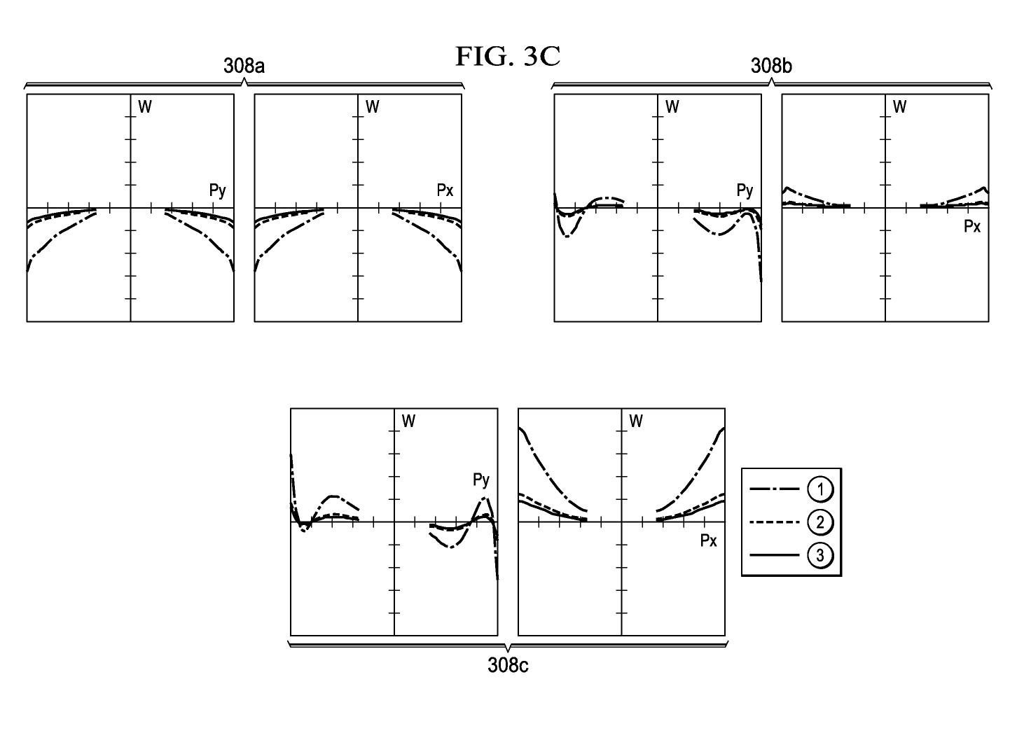

Referring to FIGS. 3A-3D, there is shown an exemplary optical device 200′ which is configured to have a magnification of 36× while achieving an acceptable 0.7 NA, 25 mm working distance, a 2.7 mm diameter object field, and 20% central obscuration in accordance with an embodiment of the present invention. As shown in FIG. 3A, the exemplary optical device 200′ includes the first objective 202 and the second objective 204. The first objective 202 has a 34 mm φ first primary concave mirror 206 with the 10 mm aperture 208 located in the center thereof, and a 14 mm φ first secondary convex mirror 210. The second objective 204 has a 61 mm φ second primary concave mirror 212 with the 4 mm aperture 214 located in a center thereof, and a 12 mm φ second secondary convex mirror 216. As shown, the first objective 202 and the second objective 204 are placed in series on an axis 218 with respect to one another in a manner such that there is 156 mm from the long conjugate plane 240 to the first objective 202, and 256 mm from the long conjugate plane 240 to the short conjugate focus plane 232. In this example, the first objective 202 has a finite-finite conjugate form and the second objective 204 has a finite-finite conjugate form which are associated with a microscopy setup. Plus, both the first primary concave mirror 206 and the second primary concave mirror 212 are aspheres. In FIG. 3B, there is a graph 302 which respectively shows the aspheric surface profiles 304 and 306 of the first primary concave mirror 206 and the second primary concave mirror 212. In the graph 302, the x-axis represents radial height (mm), and the y-axis represents the departure from best fit sphere (BFS) (mm).

The image quality of the exemplary optical device 200′ can be seen by the graphs in FIGS. 3C and 3D. As shown in FIG. 3C, there are three graphs 308a, 308b and 308c which indicate the optical path difference across the pupil 310 for three field points 312a, 312b and 312c based on the design of the exemplary optical device 200′ (see FIG. 3A for the pupil 310 and three field points 312a, 312b and 312c). The three graphs 308a, 308b and 308c respectively have object heights of axis 0 mm, 0.945 mm and 1.35 mm. Plus, the three graphs 308a, 308b and 308c have with a maximum scale of ±0.125 waves in which 0.190, 0.633, and 0.830 nm are respectively indicated in the plots as “1”, “2”, and “3”. In graphs 308a, 308b and 308c, the x-axis is represented by the fractional pupil (Py or Px), and the y-axis is represented by W (waves). As shown in FIG. 3D, there is a graph 312 which displays the root mean square (RMS) wavefront error for three different wavelengths 314a (polychromatic), 314b (0.190 nm), 314c (0.633 nm) and 314d (0.830 nm) across the field of view of the exemplary optical device 200′. In graph 312, the x-axis represents the field of view (mm), and the y-axis represents the RMS wavefront error (waves).

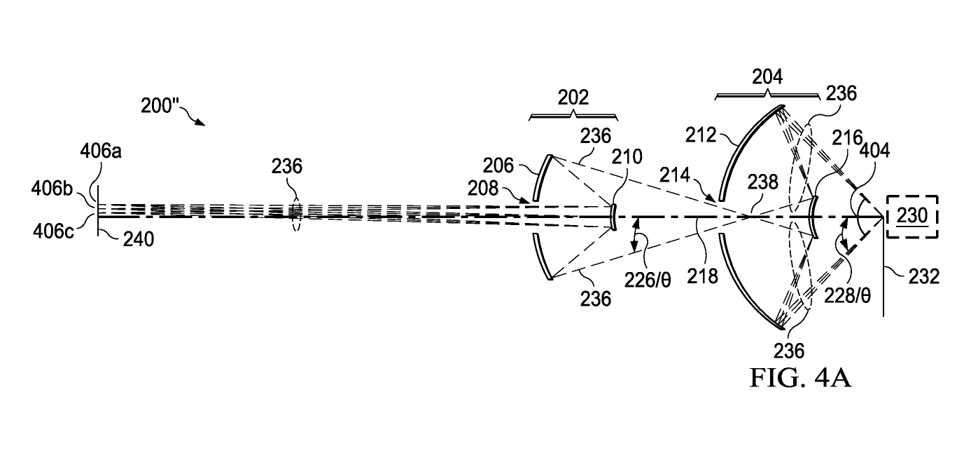

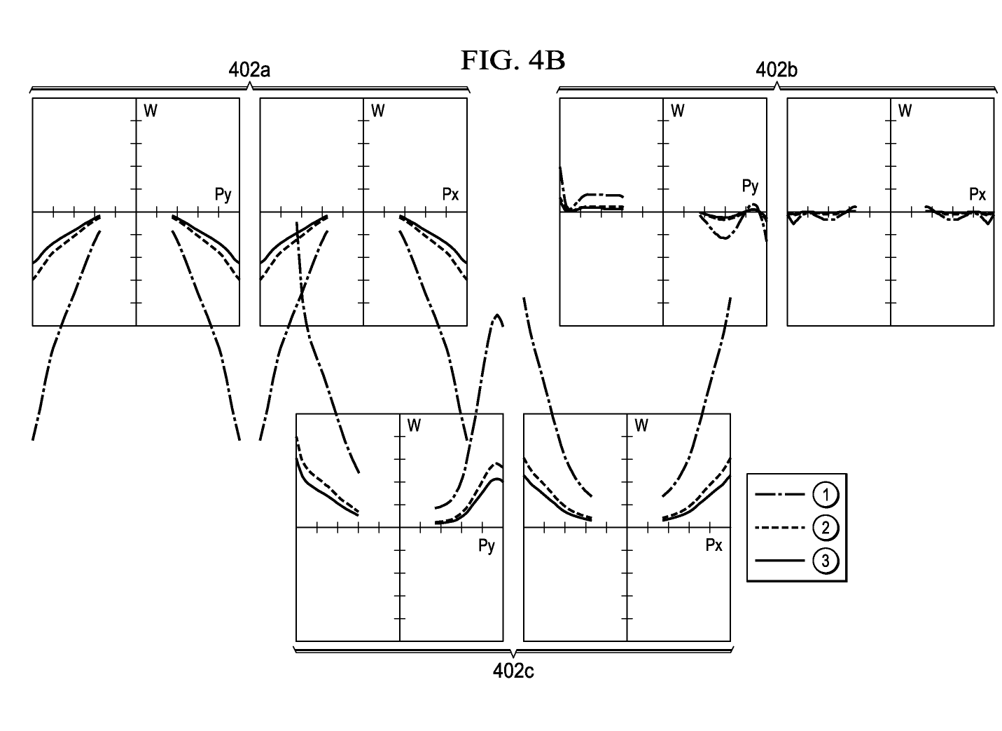

Referring to FIGS. 4A-4B, there is shown another exemplary optical device 200″ which is configured to have a magnification of 15× while achieving an acceptable 0.6 NA, 25 mm working distance, a 2.7 mm diameter object field, and 20% central obscuration in accordance with an embodiment of the present invention. As shown in FIG. 4A, the exemplary optical device 200″ includes the first objective 202 and the second objective 204. The first objective 202 has a 60.6 mm φ first primary concave mirror 206 with the 10 mm aperture 208 located in the center thereof, and a 13 mm φ first secondary convex mirror 210. The second objective 204 has a 64 mm φ second primary concave mirror 212 with the 4_mm aperture 214 located in a center thereof, and a 11 mm φ second secondary convex mirror 216. As shown, the first objective 202 and the second objective 204 are placed in series on an axis 218 with respect to one another in a manner such that there is 178 mm from the long conjugate plane 240 to the first objective 202, and 336.7 mm from the long conjugate plane 240 to the short conjugate focus plane 232. In this example, the first objective 202 has a finite-finite conjugate form and the second objective 204 has a finite-finite conjugate form which are associated with a microscopy setup. Plus, both the first primary concave mirror 206 and the second primary concave mirror 212 are aspheres. The image quality of the exemplary optical device 200″ can be seen by the graphs in FIG. 4B. As shown in FIG. 4B, there are three graphs 402a, 402b and 402c which indicate the optical path difference across the pupil 404 for three field points 406a, 406b and 406c based on the design of the exemplary optical device 200″ (see FIG. 4A for the pupil 404 and three field points 406a, 406b and 406c). The three graphs 402a, 402b and 402c respectively have object heights of axis 0 mm, 0.945 mm and 1.35 mm. Plus, the three graphs 402a, 402b and 402c have with a maximum scale of ±0.125 waves in which 0.190, 0.633, and 0.830 nm are respectively indicated in the plots as “1”, “2”, and “3”. In graphs 402a, 402b and 402c, the x-axis is represented by Py or Px (fractional pupil in X or Y), and the y-axis is represented by W (waves).

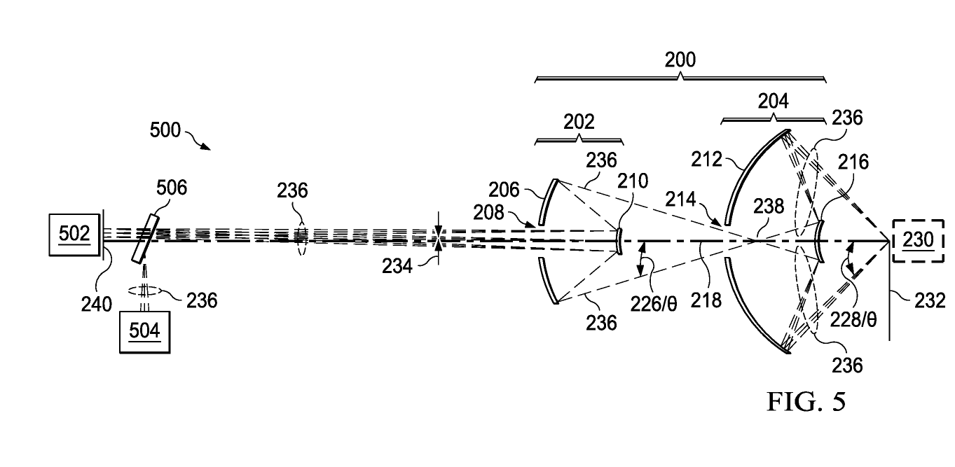

Referring to FIG. 5, there is a diagram of an imaging system 500 which incorporates the aforementioned optical device 200 and is configured to image a specimen 230 in accordance with an embodiment of the present invention. The imaging system 500 includes a viewing-detection system 502 (e.g., camera 502), an optional light source 504, an optional beam splitter 506, and the optical device 200 which are collectively used to image the specimen 230. In this example, the viewing-detection system 502 is positioned at the long conjugate focus plane 240 of the optical device 200, and the specimen 230 is positioned at the short conjugate focus plane 232 of the optical device 200. The light source 504 directs light 236 to the beam splitter 506 which diverts the light 236 to the optical device 200 which directs the light 236 to the specimen 230 and then the light 236 emitted from specimen 230 is collected by the optical device 200 and then directed through the beams splitter 506 to the viewing-detection system 502. Alternatively, the specimen 230 can be illuminated in another manner such as back light, dark field illumination, self-illumination (for instance) rather than using the light source 504 and the beam splitter 506.

In this example, the imaging system 500 is configured such that the light source 504 emits light 236 to the beam splitter 506 which re-directs the light 236 through the aperture 208 in the first primary concave mirror 206 to the first secondary convex mirror 210. The first secondary convex mirror 210 reflects the light 236 towards the first primary concave mirror 206. The first primary concave mirror 206 reflects the light 236 through the aperture 214 in the second primary concave mirror 212 to the second secondary convex mirror 216. The second secondary convex mirror 216 reflects the light 236 towards the second primary concave mirror 212. The second primary concave mirror 212 reflects the light 236 to illuminate the specimen 230 which is located a predetermined distance 231 (e.g., working distance 231) from the second objective 204. Thereafter, the second primary concave mirror 212 receives the light 236 from the specimen 230 and focuses the light 236 toward the second secondary convex mirror 216. The second secondary convex mirror 216 reflects the light 236 to produce an intermediate image 238 prior to the aperture 214 in the second primary concave mirror 212 so that the light 236 can pass through the aperture 214 located in the second primary concave mirror 212. Then, the first primary concave mirror 206 collects the light 236 which passed through the aperture 214 in the second primary concave mirror 212 and focuses the light 236 toward the first secondary convex mirror 210. The first secondary convex mirror 210 reflects the light 236 through the aperture 208 in the first primary concave mirror 206 such the light 236 passes through the beam splitter 506 and is focused on the long conjugate plane 240 and received by the viewing-detection system 502.

As can be seen, the imaging system 500 incorporates the optical device 200 which has two Schwarzschild-like objectives 202 and 204 placed in series with one another in a manner which minimizes the central obscuration 234 while allowing a significant NA 228 with respect to short conjugate focus plane 232. The long working distance 231 from the second objective 204 allows other mechanisms to be used under the objectives 202 and 204 while viewing the specimen 230. The specimen 230 (e.g., sample, wafer, etc.) is typically located at the short conjugate focus plane 232. The viewing-detection system 502 is typically located at the long conjugate focus plane 240. Each objective 202 and 204 is used in a finite-finite conjugate form. The light 236 from the specimen 230 is collected by the primary concave mirror 212 of the second objective 204. The primary concave mirror 212 then focuses the light 236 back toward the secondary convex mirror 216 of the second objective 204. The secondary convex mirror 216 then produces the intermediate image 238 of the specimen 230 close to the primary concave mirror 212. This allows the aperture 214 in the primary concave mirror 212 to be small. The light 236 travels through the aperture 214 in the primary concave mirror 212 of the second objective 204 and into the primary concave mirror 206 of the first objective 202. The primary concave mirror 206 of the first objective 202 then focuses the light 236 toward the secondary convex mirror 210 of the first objective 202. The secondary convex mirror 210 then reflects the light 236 to focus at the detector plane of the viewing-detector system 502. The unique configuration of the all-reflective optical device 200 enables the light 236 from the second objective 204 to enter the first objective 202 at a smaller NA 226 than the NA 228 of the light 236 collected from the specimen 236 while minimizing the central obscuration 234. Further, the unique configuration of the all-reflective optical device 200 allows aberrations to be corrected at different locations in the mirrors 206, 210, 212 and 216. In particular, the reflective surfaces of the mirrors 206, 210, 212 and 216 can be spherical, aspherical or a combination of both to correct aberrations and to improve the wavefront performance.

Referring to FIG. 6, there is a block diagram of an optical device 600 which is configured in accordance with another embodiment of the present invention. The optical device 600 includes a first objective 602 and a second objective 604. The first objective 602 has a first primary concave mirror 606 with an aperture 608 located in the center thereof, and a first secondary convex mirror 610. The second objective 604 has a second primary concave mirror 612 with an aperture 614 located in a center thereof, and a second secondary convex mirror 616. As shown, the first objective 602 and the second objective 604 are placed in series on an axis 618 with respect to one another in a manner such that the first objective 602 has an infinite conjugate 620 and the second objective 604 has a relatively short conjugate 622. In particular, the first objective 602 is used in a infinite-finite conjugate form and the second objective 604 is used a finite-finite conjugate form which are associated with a microscopy setup (compare to FIG. 2). In this microscopy setup, the first objective 602 has a relatively small numerical aperture 626, and the second objective 604 has a relatively large numerical aperture 628 (note: NA 626 and 628 is a dimensionless number which characterizes the range of angles over which the corresponding objective 602 and 604 can accept or emit light 636—NA=n sin θ where n is the index of refraction of the medium in which the corresponding objective 602 and 604 is working and θ is the half-angle of the maximum cone of the light 636 that can enter or exit the corresponding objective 602 and 604 with respect to an image point P). In particular, the optical device 600 has reflective components 606, 610, 612 and 616 is configured to have the large NA 628 with respect to a specimen 630 (e.g., sample 630, wafer 630) while at the same time having a small central obscuration 634. The specimen 630 which is to be imaged is placed at the short conjugate's focus plane 632. The following is a detailed discussion about how light 636 from the specimen 630 is collected by the optical device 600 and then emitted from the optical device 600.

The optical device 600 is configured such that the second primary concave mirror 612 receives the light 636 from the specimen 630 which is located a predetermined distance 631 (e.g., working distance 631) from the second objective 604. The second primary concave mirror 612 focuses the light 636 toward the second secondary convex mirror 616. The second secondary convex mirror 616 reflects the light 636 to produce an intermediate image 638 prior to the aperture 614 in the second primary concave mirror 612 so that the light 636 can pass through the aperture 614 located in the second primary concave mirror 612. Then, the first primary concave mirror 606 collects the light 636 which passed through the aperture 614 in the second primary concave mirror 612 and focuses the light 636 toward the first secondary convex mirror 610. The first secondary convex mirror 610 reflects the light 636 through the aperture 608 in the first primary concave mirror 606 such the light 636 is directed (not focused) to the long conjugate plane 640. As shown, the light 636 from the second objective 604 enters the first objective 602 which has the smaller NA 626 than the NA 628 of the second objective 604 which collects the light 636 from the specimen 630. As a result, this particular setup of the optical device 600 effectively minimizes the central obscuration 634. In addition, this particular setup of the optical device 600 allows aberrations in the first and second objectives 602 and 604 to be corrected at different locations. More specifically, since the optical system 600 utilizes all reflective surfaces in the first and second objectives 602 and 604 this enables both spherical surfaces as well as aspherical surfaces to be used therein as desired to correct aberrations and improve the wavefront performance of the objectives 602 and 604.

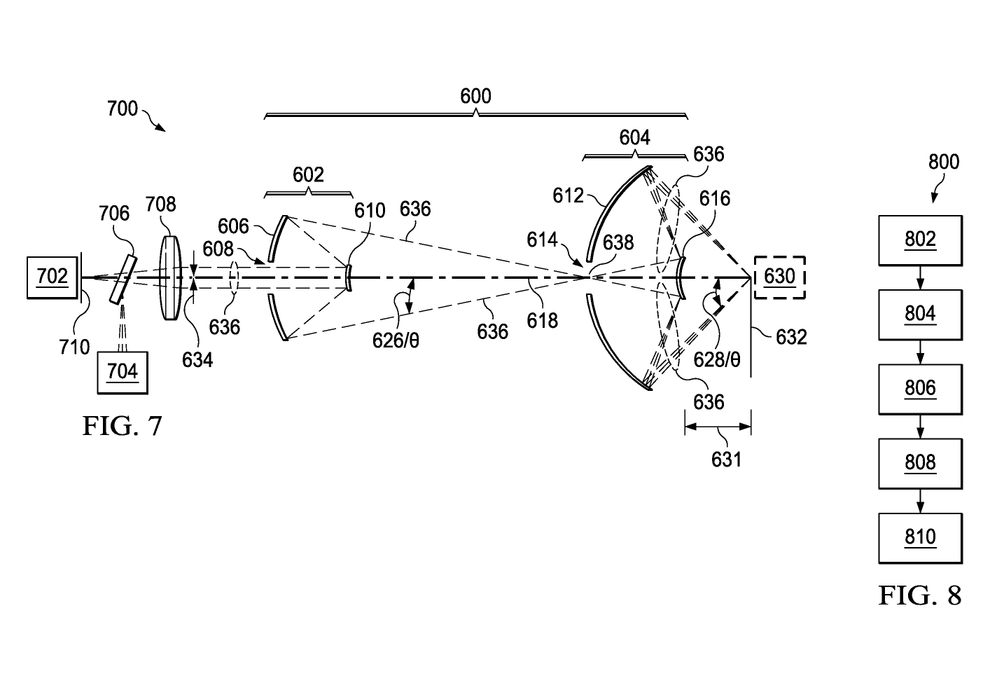

Referring to FIG. 7, there is a diagram of an imaging system 700 which incorporates the aforementioned optical device 600 and is configured to image a specimen 630 in accordance with an embodiment of the present invention. The imaging system 700 includes a viewing-detection system 702 (e.g., camera 702), an optional light source 704, an optional beam splitter 706, a tube lens 708 (or a set of lenses 708), and the optical device 600 which are collectively used to image the specimen 630. In this example, the viewing-detection system 702 is positioned at a focal plane 710 of the tube lens 708, and the specimen 630 is positioned at the short conjugate focus plane 632 of the optical device 600. The light source 704 directs light 636 to the beam splitter 706 which diverts the light 636 to the optical device 600 which directs the light 636 to the specimen 630 and then the light 636 emitted from specimen 630 is collected by the optical device 600 and then directed through the beams splitter 706 to the viewing-detection system 702. Alternatively, the specimen 630 can be illuminated in another manner such as back light, dark field illumination, self-illumination (for instance) rather than using the light source 704 and the beam splitter 706.

In this example, the imaging system 700 is configured such that the light source 704 emits light 636 to the beam splitter 706 which re-directs the light 636 through the aperture 608 in the first primary concave mirror 606 to the first secondary convex mirror 610. The first secondary convex mirror 610 reflects the light 636 towards the first primary concave mirror 606. The first primary concave mirror 606 reflects the light 636 through the aperture 614 in the second primary concave mirror 612 to the second secondary convex mirror 616. The second secondary convex mirror 616 reflects the light 636 towards the second primary concave mirror 612. The second primary concave mirror 612 reflects the light 636 to illuminate the specimen 630 which is located a predetermined distance 631 (e.g., working distance 631) from the second objective 604. Thereafter, the second primary concave mirror 612 receives the light 636 from the specimen 630 and focuses the light 636 toward the second secondary convex mirror 616. The second secondary convex mirror 616 reflects the light 636 to produce an intermediate image 638 prior to the aperture 614 in the second primary concave mirror 612 so that the light 636 can pass through the aperture 614 located in the second primary concave mirror 612. Then, the first primary concave mirror 606 collects the light 636 which passed through the aperture 614 in the second primary concave mirror 612 and focuses the light 636 toward the first secondary convex mirror 610. The first secondary convex mirror 610 reflects the light 636 through the aperture 608 in the first primary concave mirror 606 such the light 638 passes through tube lens 708 and the beam splitter 706 and is focused on the tube lens's focus plane 710 and received by the viewing-detection system 702.

As can be seen, the imaging system 700 incorporates the optical device 600 which has two Schwarzschild-like objectives 602 and 604 placed in series with one another in a manner which minimizes the central obscuration 634 while allowing a significant NA 628 with respect to the short conjugate focus plane 632. The long working distance 631 from the second objective 604 allows other mechanisms to be used under the objectives 602 and 604 while viewing the specimen 630. The specimen 630 (e.g., sample, wafer, etc.) is typically located at the short conjugate focus plane 632. The viewing-detection system 702 is typically located at the tube lens's focus plane 710. The first objective 602 has an infinite-finite conjugate form and the second objective 604 has a finite-finite conjugate form. The light 636 from the specimen 630 is collected by the primary concave mirror 612 of the second objective 604. The primary concave mirror 612 then focuses the light 636 back toward the secondary convex mirror 616 of the second objective 604. The secondary convex mirror 616 then produces the intermediate image 638 of the specimen 630 close to the primary concave mirror 612. This allows the aperture 614 in the primary concave mirror 612 to be small. The light 636 travels through the aperture 614 in the primary concave mirror 612 of the second objective 604 and into the primary concave mirror 606 of the first objective 602. The primary concave mirror 606 of the first objective 602 then focuses the light 636 toward the secondary convex mirror 610 of the first objective 602. The secondary convex mirror 610 then reflects the light 636 to the tube lens 708 which focuses the light 636 at the detector plane of the viewing-detector system 702. The unique configuration of the all-reflective optical device 600 enables the light 636 from the second objective 604 to enter the first object 602 at a smaller NA 626 than the NA 628 of the light 636 collected from the specimen 636 while minimizing the central obscuration 634. Further, the unique configuration of the all-reflective optical device 600 allows aberrations to be corrected at different locations in the mirrors 606, 610, 612 and 616. In particular, the reflective surfaces of the mirrors 606, 610, 612 and 616 can be spherical, aspherical or a combination of both to correct aberrations and to improve the wavefront performance.

Referring to FIG. 8, there is a flowchart illustrating the steps of a method 800 for imaging a specimen 230 and 630 in accordance with an embodiment of the present invention. The method 800 comprises the steps of: (a) providing a viewing-detection system 502 and 702 (step 802); (b) providing an optical device 200 and 600 which comprises a first objective 202 and 602 and a second objective 204 and 604 which are placed in series with respect to one another, wherein the first objective 202 and 602 has a first primary concave mirror 206 and 606 with an aperture 208 and 608 located in a center thereof, and a first secondary convex mirror 210 and 610, and wherein the second objective 204 and 604 has a second primary concave mirror 212 and 612 with an aperture 214 and 614 located in a center thereof, and a second secondary convex mirror 216 and 616 (step 804); (c) positioning the viewing-detection system 502 and 702 at a predetermined distance (e.g., the long conjugate focus plane 240 of the optical device 200, the focus plane 710 of the tube lens 708) from the first objective 202 and 602 (step 806); (d) positioning the specimen 230 and 630 at a predetermined distance (e.g., the small conjugate focus plane 232 and 632) from the second objective 204 and 604 (step 808); and (e) receiving, at the viewing-detection system 502 and 702, the light 236 and 636 from the specimen 230 and 630 which had first passed through the second objective 204 and 604 which has a relatively large numerical aperture 228 and 628 and then had passed through the first objective 202 and 602 which has a relatively small numerical aperture 226 and 626 (step 810).

Although multiple embodiments of the present invention have been illustrated in the accompanying Drawings and described in the foregoing Detailed Description, it should be understood that the invention is not limited to the disclosed embodiments, but is capable of numerous rearrangements, modifications and substitutions without departing from the invention as set forth and defined by the following claims. It should also be noted that the reference to the “present invention” or “invention” used herein relates to exemplary embodiments and not necessarily to every embodiment that is encompassed by the appended claims.

1. An optical device comprising:
a first objective comprising:
a first primary concave mirror with an aperture located in a center thereof; and
a first secondary convex mirror;
a second objective comprising:
a second primary concave mirror with an aperture located in a center thereof; and
a second secondary convex mirror;
the first objective and the second objective are placed in series on an axis with respect to one another; where the second objective has a relatively large numerical aperture and the first objective has a relatively small numerical aperture.

2. The optical device of claim 1, wherein the first objective and the second objective are positioned with respect to one another such that the second primary concave mirror receives light and focuses the light toward the second secondary convex mirror, where the second secondary convex mirror reflects the light to produce an intermediate image prior to the aperture in the second primary concave mirror so that the light passes through the aperture located in the second primary concave mirror, where the first primary concave mirror collects the light which passed through the aperture in the second primary concave mirror and focuses the light toward the first secondary convex mirror, where the first secondary convex mirror reflects the light through the aperture in the first primary concave mirror to the viewing-detection system.

3. The optical device of claim 1, wherein the first objective is used in a finite-finite conjugate form and the second objective is used a finite-finite conjugate form.

4. The optical device of claim 1, wherein the first objective is used in a finite-infinite conjugate form and the second objective is used a finite-finite conjugate form.

5. The optical device of claim 1, wherein the first primary concave mirror, the first secondary convex mirror, the second primary concave mirror, and the second secondary convex mirror each have spherical surfaces, aspherical surfaces or some combination thereof.

6. The optical device of claim 1, wherein the optical device has a magnification in a range of 10×-20×, a working distance in a range of about 20 mm, a central obscuration in a range of <35%, the first objective has the relatively small numerical aperture in a range of about 0.2, and the second objective has the relatively large numerical aperture in a range of about 0.6-0.7.

7. An imaging system for imaging a specimen, the imaging system comprising:
a viewing-detection system;
an optical device comprising:
a first objective comprising:
a first primary concave mirror with an aperture located in a center thereof; and
a first secondary convex mirror;
a second objective comprising:
a second primary concave mirror with an aperture located in a center thereof; and
a second secondary convex mirror;
the first objective and the second objective are placed in series on an axis with respect to one another;
the viewing-detection system is positioned a predetermined distance from the first objective, and the specimen is positioned a predetermined distance from the second objective, where light from the specimen passes through the second objective which has a relatively large numerical aperture and then the light passes through the first objective which has a relatively small numerical aperture before the light is received by the viewing-detection system.

8. The imaging system of claim 7, wherein the optical device is configured where the second primary concave mirror receives the light from the specimen and focuses the light toward the second secondary convex mirror, where the second secondary convex mirror reflects the light to produce an intermediate image of the specimen prior to the aperture in the second primary concave mirror so that the light passes through the aperture located in the second primary concave mirror, where the first primary concave mirror collects the light which passed through the aperture in the second primary concave mirror and focuses the light toward the first secondary convex mirror, where the first secondary convex mirror reflects the light through the aperture in the first primary concave mirror to the viewing-detection system.

9. The imaging system of claim 7, wherein the first objective is used in a finite-finite conjugate form and the second objective is used a finite-finite conjugate form.

10. The imaging system of claim 7, wherein the first objective is used in a finite-infinite conjugate form and the second objective is used a finite-finite conjugate form, and wherein one or more lenses would be located between the first objective and the viewing-detector system.

11. The imaging system of claim 7, wherein the first primary concave mirror, the first secondary convex mirror, the second primary concave mirror, and the second secondary convex mirror each have spherical surfaces, aspherical surfaces or some combination thereof.

12. The imaging system of claim 7, wherein the optical device has a magnification in a range of 10×-20×, a working distance in a range of about 20 mm, a central obscuration in a range of <35%, the first objective has the relatively small numerical aperture in a range of about 0.2, and the second objective has the relatively large numerical aperture in a range of about 0.6-0.7.

13. A method for imaging a specimen, the method comprising the steps of:
providing a viewing-detection system;
providing an optical device comprising:
a first objective comprising:
a first primary concave mirror with an aperture located in a center thereof; and
a first secondary convex mirror;
a second objective comprising:
a second primary concave mirror with an aperture located in a center thereof; and
a second secondary convex mirror;
the first objective and the second objective are placed in series on an axis with respect to one another;
positioning the viewing-detection system device a predetermined distance from the first objective;
positioning the specimen a predetermined distance from the second objective; and
receiving, at the viewing-detection system, light from the specimen which had first passed through the second objective which has a relatively large numerical aperture and then passed through the first objective which has a relatively small numerical aperture.

14. The method of claim 13, wherein the optical device is configured where the second primary concave mirror receives the light from the specimen and focuses the light toward the second secondary convex mirror, where the second secondary convex mirror reflects the light to produce an intermediate image of the specimen prior to the aperture in the second primary concave mirror so that the light passes through the aperture located in the second primary concave mirror, where the first primary concave mirror collects the light which passed through the aperture in the second primary concave mirror and focuses the light toward the first secondary convex mirror, where the first secondary convex mirror reflects the light through the aperture in the first primary concave mirror to the viewing-detection system.

15. The method of claim 13, wherein the first objective is used in a finite-finite conjugate form and the second objective is used a finite-finite conjugate form.

16. The method of claim 13, wherein the first objective is used in a finite-infinite conjugate form and the second objective is used a finite-finite conjugate form.

17. The method of claim 13, wherein the first primary concave mirror, the first secondary convex mirror, the second primary concave mirror, and the second secondary convex mirror each have spherical surfaces, aspherical surfaces or some combination thereof.

18. The method of claim 13, wherein the optical device has a magnification in a range of 10×-20×, a working distance in a range of about 20 mm, a central obscuration in a range of <35%, the first objective has the relatively small numerical aperture in a range of about 0.2, and the second objective has the relatively large numerical aperture in a range of about 0.6-0.7.
